(19) United States
(12) Patent Application Publication
(10) Pub. No.: US 2012/0149329 A1
(43) Pub. Date: Jun. 14, 2012

(54) METHOD AND APPARATUS FOR PROVIDING A SUBSIDY-LOCK UNLOCK PROCEDURE

(75) Inventors: Tarik Mahmood, Gurnee, IL (US); Matthew L. Deheck, Grayslake, IL (US)

(73) Assignee: MOTOROLA MOBILITY, INC., Libertyville, IL (US)

(21) Appl. No.: 12/965,269

(22) Filed: Dec. 10, 2010

(51) Int. Cl. H04W 12/06

(52) U.S. Cl. 455/411

(57) ABSTRACT

A method and apparatus for providing a secure subsidy-lock unlock procedure for a wireless device is disclosed. A security subsidy-lock unlock password is received. Registration of the wireless device is initiated when the received password is determined to be correct. Notification of a registration status is received. Network access is restricted or allowed based on the registration status.

### BACKGROUND

An operator subsidized-locked phone can be unlocked with a password. The password may be guessed or hacked. Once a correct password is guessed or hacked, user is free to use it on any network of same technology.

FIG. 1 illustrates an example of a prior art subsidy-lock unlock procedure where the password entered is correct. In this prior art procedure, a user turns on the mobile device. At powerup, the mobile device reads lock information (i.e. IMSI) from the Subscriber Identity Module (SIM). The mobile device prompts the user to enter an Unlock Password. Since the password is correct, the mobile device erases the secure subsidy lock information and the user is allowed to use the network.

FIG. 2 illustrates an example of a prior art subsidy-lock unlock procedure where the password entered is incorrect. In this prior art procedure, a user turns on the mobile device. At powerup, the mobile device reads lock information (i.e. IMSI) from the SIM. The mobile device prompts the user to enter an unlock password. Since the password entered is incorrect, the mobile device prompts the user to enter the password again until the proper password is entered.

As previously mentioned, this method is insecure since the password can be hacked. Therefore there is a need in the art for providing a more secure subsidy-lock unlock procedure.

### SUMMARY

A method and apparatus for providing a secure subsidy-lock unlock procedure for a wireless device is disclosed. A security subsidy-lock unlock password is received. Registration of the wireless device is initiated when the received password is determined to be correct. Notification of a registration status is received. Network access is restricted or allowed based on the registration status.

When the registration status indicates a successful registration, secure subsidy lock information is erased and network access is allowed. Network access may be allowed by unlocking a display of the wireless device.

When the registration status indicates an unsuccessful registration, network access is restricted. Network access may be restricted by locking a display of the wireless device.

The wireless device may have a pre-defined list of networks pre-stored in a memory of the wireless device. Registration of the wireless device may be initiated by selecting a first network on which to register from the predefined list of networks. When the registration status indicates an unsuccessful registration for the first network, network access is restricted. When registration on the first network is unsuccessful the wireless device successively attempts to register on remaining networks of the pre-defined list until there is a successful registration. Network access is allowed upon successful registration on one of the remaining networks.

Also disclosed is an apparatus, e.g. a wireless device, for providing a secure subsidy-lock unlock procedure. A controller may implement the security subsidy unlock procedure. A user interface receives a security subsidy unlock password. The controller may use a comparator to determine whether the received subsidy unlock password is correct. The controller may use a transmitter to initiate registration of the wireless device with a network when the received password is determined to be correct. A receiver may receive notification of a registration status from the network. The controller may use the user interface to restrict or allow network access based on the registration status.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an example of a prior art subsidy-lock unlock procedure where the password entered is correct;

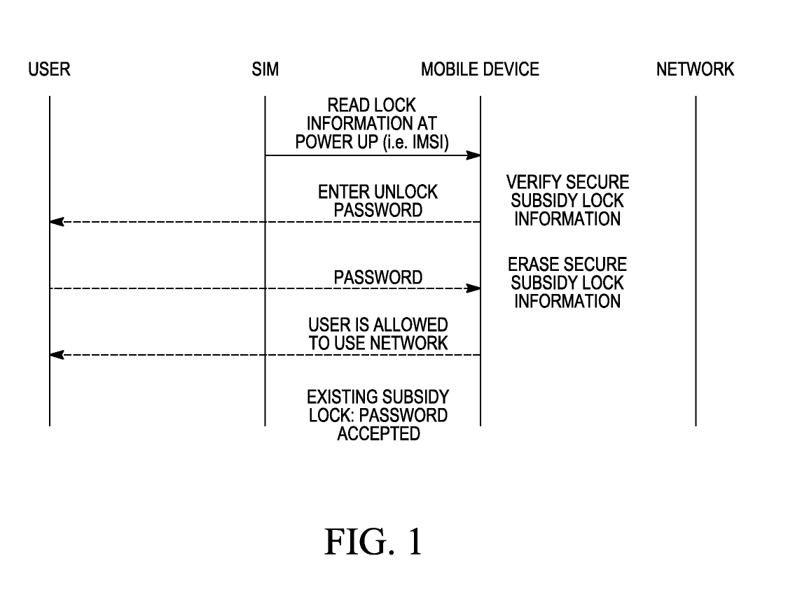

FIG. 2 illustrates an example of a prior art subsidy-lock unlock procedure where the password entered is incorrect;

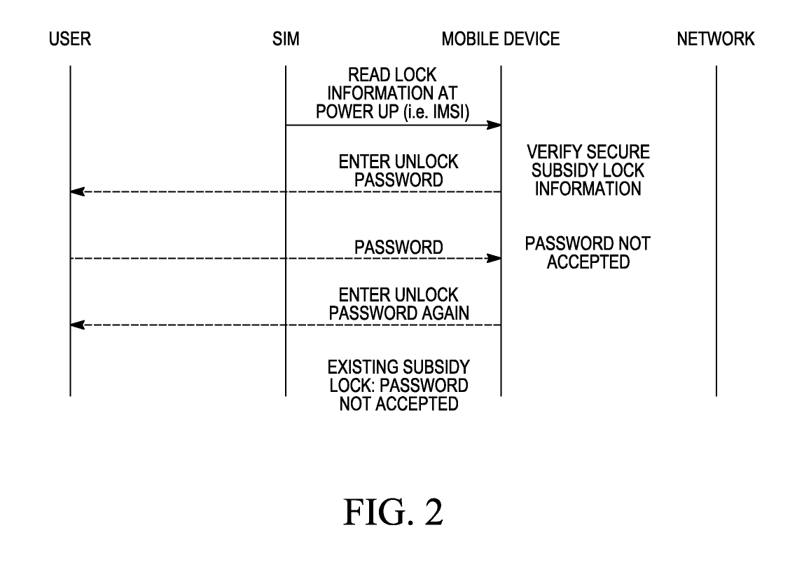

FIG. 3 illustrates a subsidy-lock unlock procedure method according to one embodiment;

FIG. 4 illustrates a wireless communication device according to one embodiment;

FIG. 5 illustrates a subsidy-lock unlock procedure according to one embodiment;

FIG. 6 illustrates the subsidy-lock unlock procedure of FIG. 5 in further detail according to one embodiment;

FIG. 7 illustrates a subsidy-lock unlock procedure according to one embodiment;

FIG. 8 illustrates the subsidy-lock unlock procedure of FIG. 7 in further detail according to one embodiment;

FIG. 9 illustrates a subsidy-lock unlock procedure according to one embodiment; and

FIG. 10 illustrates the subsidy-lock unlock procedure of FIG. 9 in further detail according to one embodiment.

### DETAILED DESCRIPTION

Entering the correct subsidy lock password typically unlocks the phone. With this disclosure, entering correct password is a step toward unlocking the phone. After that, the phone must register on one of the networks configured by the subsidized operator.

As long as the phone is subsidy locked, only the operator configured network list shall be considered for registration except for home network Subscriber Identity Module (SIM).

This disclosure is distinguishable from current password-based unlock procedures in that after successful entry of the unlock password, the phone must register successfully with one of the networks in the “un-lock Public Land Mobile Network (PLMN) list” before the phone will actually be unlocked. This list is supplied by the operator and pre-stored in the phone exclusively for this purpose.

In one embodiment, the unlock can be restricted to only occur in the coverage area of one of the systems in the list. This only makes the subsidy-lock unlock procedure more secure, and prevents large scale unlock of phones that have left the continent, for example, and has the benefit that it requires very minimal change to phone software or operator procedures.

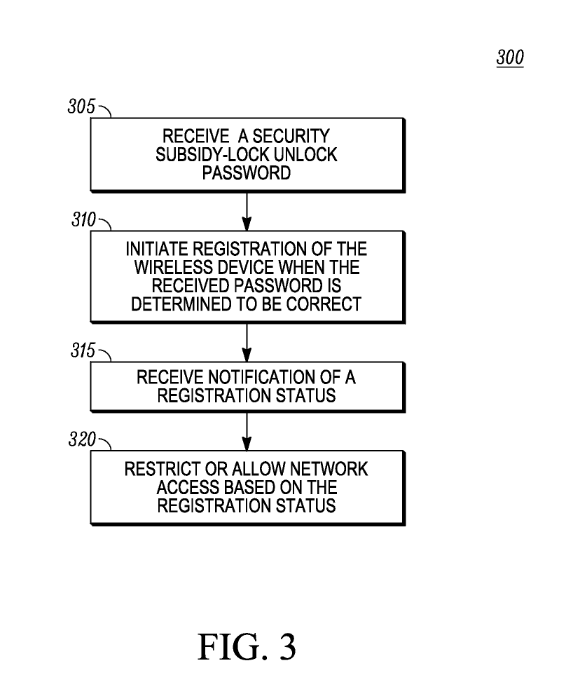

FIG. 3 illustrates a novel subsidy-lock unlock procedure method 300 according to one embodiment. At step 305, a security subsidy-lock unlock password is received. At step 310, registration of the wireless device is initiated when the received password is determined to be correct. At step 315, notification of registration status is received. At step 320, network access is restricted or allowed based on the registration status.

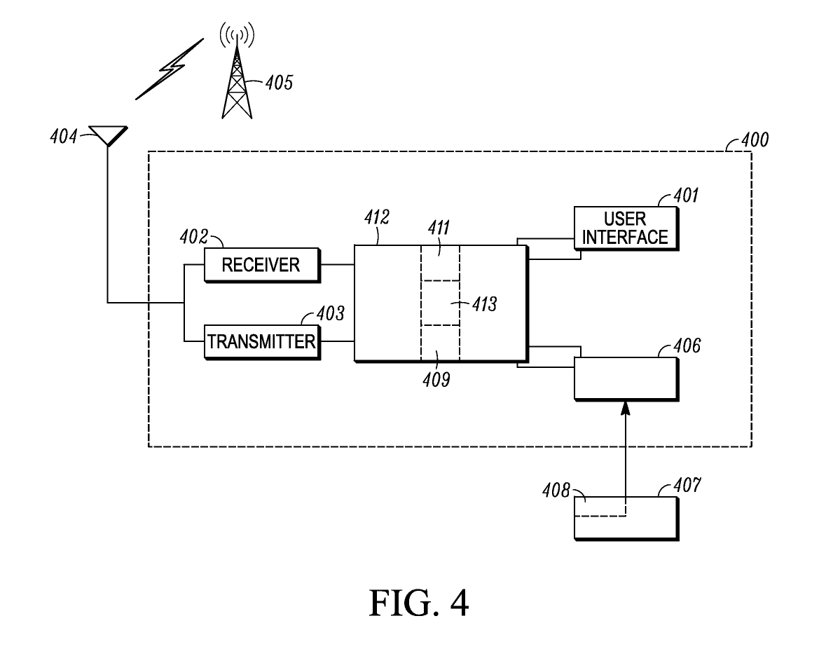

FIG. 4 illustrates one embodiment of wireless communication device 400. Wireless communication device 400 may include standard components like a user interface 401, which may include a display and a keypad or voice control system. Additionally, device 400 includes wireless communication circuitry having at least one of a receiver 402 or a transmitter 403 and an antenna 404. Where the device 400 is a one-way communication device, either the receiver 402 or transmitter 403 will be present. Where the device 400 supports two-way communication, generally both the transmitter 402 and receiver 403, or a combined transceiver (implementing the receiver and transmitter together), will be present. Any of the receiver 402, transmitter 403 or transceiver will generally employ some form of the antenna 404 to wirelessly communicate with a base station transceiver 405 associated with a wireless communication network.

Device 400 includes a user configuration module reader 406 for receiving, or otherwise coupling to, and reading data from a user configuration module 407. The information stored within the user configuration module 407 may include identification information 408 suitable for identifying at least the service provider, user or both. In one embodiment, the identification information 408 includes information identifying at least the service provider with which the user or customer has a subscription for wireless communication services.

A control unit 412, which may be a microprocessor, a group of processing components, one or more Application Specific Integrated Circuits (ASICs), programmable logic or other processing device, includes a storage device 411, a comparator 413 and application module 409. Application module 409 may include one or more of the following: a subsidy-lock application module, a phone security system module, a registration module, and a PLMN selection module. Storage device 411, comparator 413 and application module 409 may be integrated into the control unit 412, or may be independent components or software modules operating in concert with the control unit 412. Where employed as software modules, the application module 409, for example, may include one or more sets of prestored instructions for execution by the control unit 412 or another processor. In one embodiment, storage device 411 may comprise a computer-readable medium.

In one embodiment, storage device 411 has stored thereon a list comprising one or more public land mobile networks (PLMN). These PLMNs are pre-stored in memory 411 specifically for use with the subsidy-lock unlock module and are the only networks for which a valid registration, e.g. at step 310, may be accomplished.

In one embodiment, comparator 413 is used to determine whether a password entered by a user of wireless device 400 is correct. If the entered password is incorrect, access to wireless device 400 may be restricted. If the entered subsidy-lock unlock password is correct, registration on one of the pre-stored PLMNs is attempted. If registration is successful, secure subsidy lock information is erased from the wireless device and the user is allowed to use the network.

Examples of networks suitable for operation in conjunction with the method include GSM-based networks (e.g. 3G, LTE), CDMA networks, TDMA networks, DEN networks, WiMAX networks and UMTS networks. One skilled in the art having the benefit of this disclosure will readily appreciate that the teaching of this invention could be readily applied to other types of communication environments including most, if not all, types of communication networks. Other networks capable of exchanging voice and other data, including various types of wireless local area networks, will also be suitable for use with the methods and systems described herein.

Where device 400 is a device suitable for operation within a GSM system, the user configuration module 407 may be a SIM card. In such a scenario, the identification information 408 may include a home public land mobile network.

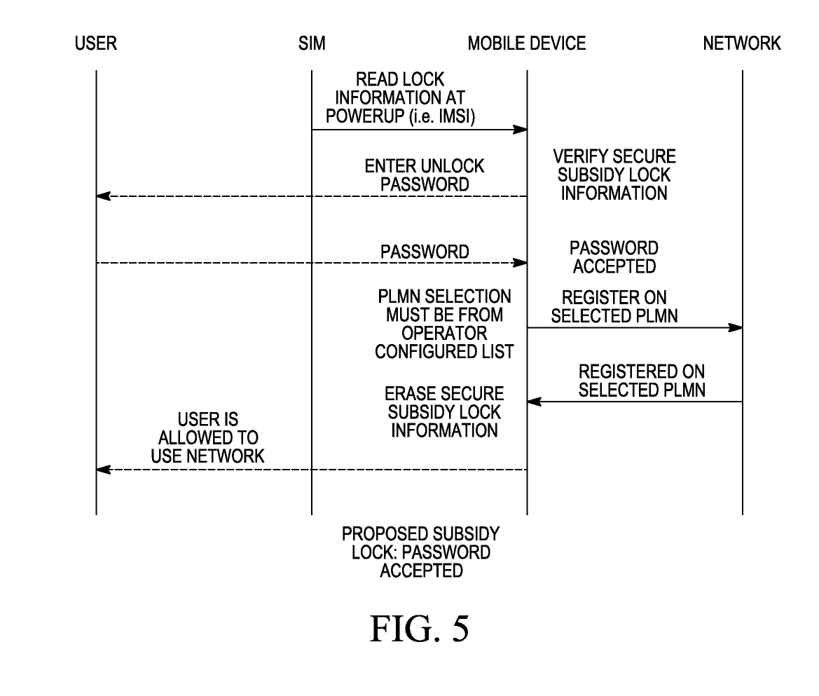

FIG. 5 illustrates a subsidy-lock unlock procedure according to one embodiment. The mobile device or phone, e.g. wireless device 400, reads lock information from the SIM at powerup (i.e. International Mobile Subscriber Identity (IMSI)). The mobile device verifies secure subsidy lock information by prompting the user to enter an unlock password. If the password is correct/accepted, the mobile device selects a PLMN from an operator configured list and attempts to register on the selected PLMN. If registration on the selected PLMN is successful, the mobile device erases the secure subsidy lock information and the user is allowed to use the network.

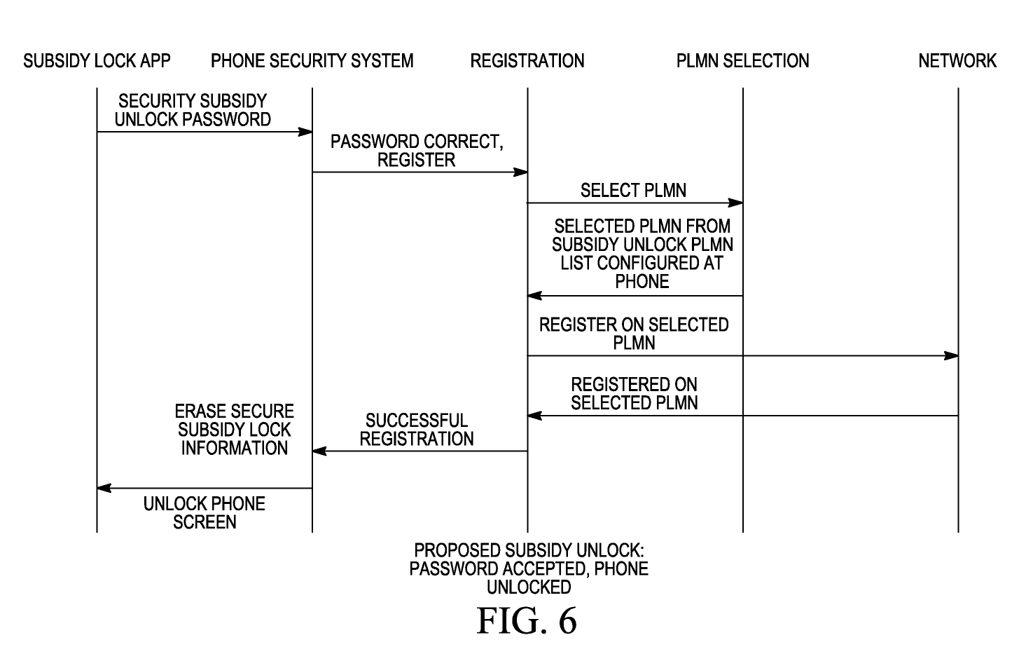

FIG. 6 illustrates the subsidy-lock unlock procedure of FIG. 5 in further detail according to one embodiment. A subsidy lock application provides a security subsidy unlock password to the phone security system. The phone security system determines, e.g. using password comparator 413, whether the provided security subsidy unlock password is correct. If the password is correct, registration is initiated via the registration module. Registration module selects a PLMN from a Subsidy Unlock PLMN List configured at the wireless device, e.g. phone. The registration module then attempts to register on the selected PLMN. If registration on the selected PLMN is successful, the registration module notifies the phone security system of the successful registration. The phone security system then erases the secure subsidy lock information from the wireless device and unlocks the screen of the wireless device.

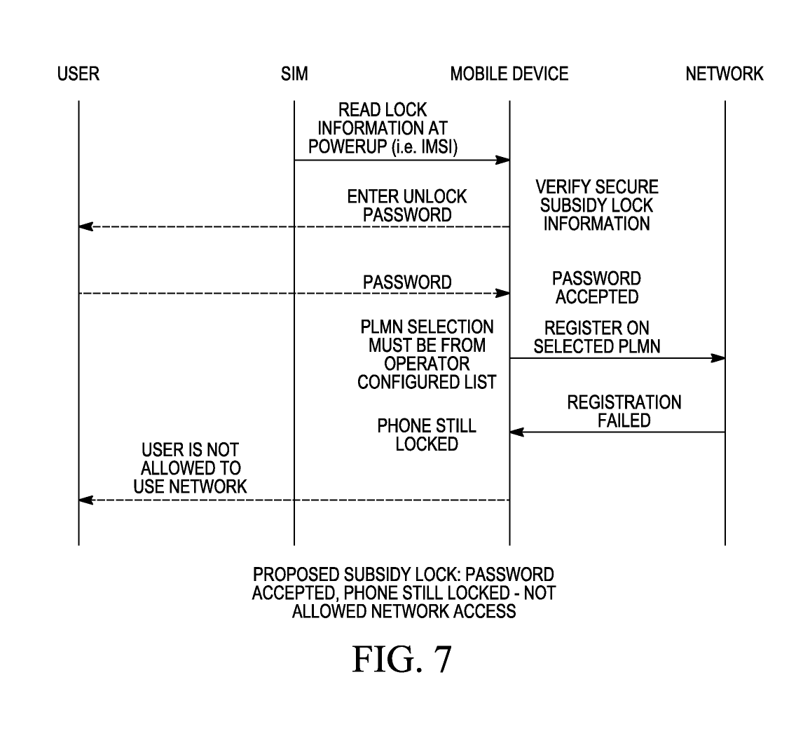

FIG. 7 illustrates a subsidy-lock unlock procedure according to one embodiment. The mobile device or phone, e.g. wireless device 400, reads lock information from the SIM at powerup (i.e. International Mobile Subscriber Identity (IMSI)). The mobile device verifies secure subsidy lock information by prompting the user to enter an unlock password. If the password is correct/accepted, the mobile device selects a PLMN from an operator configured list and attempts to register on the selected PLMN. If registration on the selected PLMN is unsuccessful, e.g. registration has failed, the wireless device remains locked and the user is not allowed to use the network, i.e. network access is restricted.

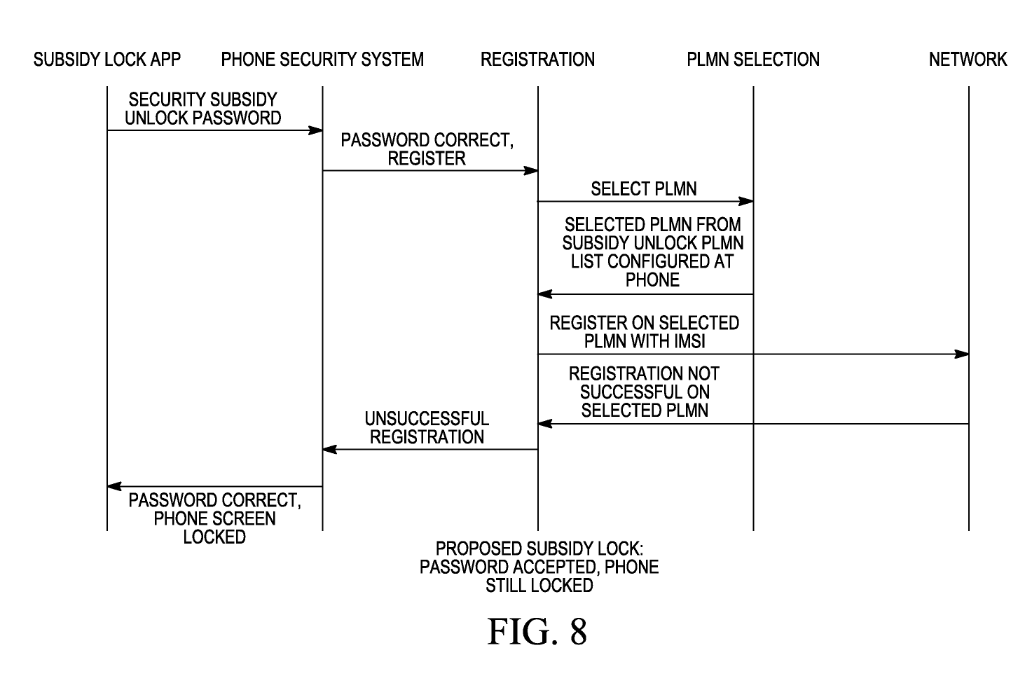

FIG. 8 illustrates the subsidy-lock unlock procedure of FIG. 7 in further detail according to one embodiment. A subsidy lock application provides a security subsidy unlock password to the phone security system. The phone security system determines, e.g. using password comparator 413, whether the provided security subsidy unlock password is correct. If the password is correct, registration is initiated via the registration module. Registration module selects a PLMN from a Subsidy Unlock PLMN List configured at the wireless device, e.g. phone. The registration module then attempts to register on the selected PLMN. If registration on the selected PLMN is unsuccessful, the registration module notifies the phone security system of the unsuccessful registration. The phone security system then restricts access to the network by locking a screen of the wireless device.

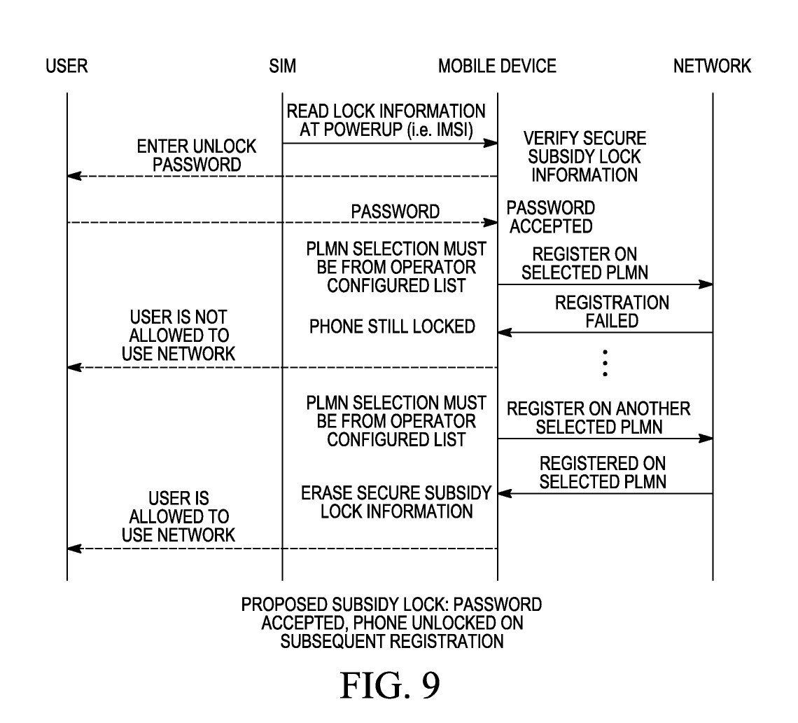

FIG. 9 illustrates a subsidy-lock unlock procedure according to one embodiment. The mobile device or phone, e.g. wireless device 400, reads lock information from the SIM at powerup (i.e. International Mobile Subscriber Identity (IMSI)). The mobile device verifies secure subsidy lock information by prompting the user to enter an unlock password. If the password is correct/accepted, the mobile device selects a PLMN from an operator configured list and attempts to register on the selected PLMN. If registration on the selected PLMN is unsuccessful, e.g. registration has failed, the wireless device remains locked and the user is not allowed to use the network, i.e. network access is restricted.

In this embodiment, after registration failure, the mobile device attempts to register on another selected PLMN from the operator configured PLMN selection list. In this embodiment, registration on the subsequently selected PLMN is successful. Since registration on the subsequently selected PLMN is successful, the mobile device erases the secure subsidy lock information and the user is allowed to use the network.

In one embodiment, after registration failure, the mobile device successively attempts to register on the remaining PLMNs from the operator configured list until the mobile device successfully registers or until registration fails for each PLMN of the operator configured list.

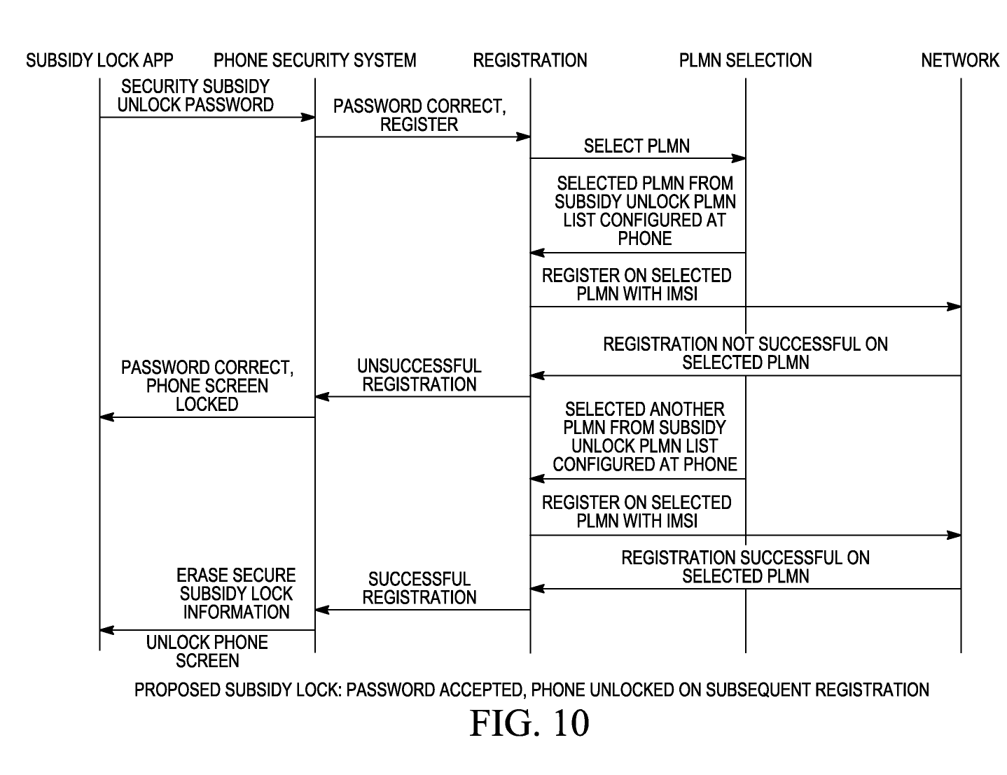

FIG. 10 illustrates the subsidy-lock unlock procedure of FIG. 9 in further detail according to one embodiment. A subsidy lock application provides a security subsidy unlock password to the phone security system. The phone security system determines, e.g. using password comparator 413, whether the provided security subsidy unlock password is correct. If the password is correct, registration is initiated via the registration module. Registration module selects a PLMN from a Subsidy Unlock PLMN List configured at the wireless device, e.g. phone. The registration module then attempts to register on the selected PLMN. In one embodiment, the registration module attempts to register on the selected PLMN with IMSI. If registration on the selected PLMN is unsuccessful, the registration module notifies the phone security system of the unsuccessful registration. The phone security system then restricts access to the network by locking a screen of the wireless device.

In this embodiment, after registration failure, the registration module of the mobile device attempts to register on another selected PLMN from the operator configured PLMN selection list. In this embodiment, registration on the subsequently selected PLMN is successful. The registration module notifies the phone security system of the successful registration on the subsequently selected PLMN. Upon notification of the successful registration the phone security system erases the secure subsidy lock information and allows network access by unlocking a screen of the wireless device.

In one embodiment, after registration failure, the registration module successively attempts to register on the remaining PLMNs from the operator configured list until the mobile device successfully registers or until registration fails for each PLMN of the operator configured list.

While the foregoing is directed to embodiments of the present invention, other and further embodiments of the invention may be devised without departing from the basic scope thereof, and the scope thereof is determined by the claims that follow.

What is claimed is:

1. A method for providing a secure subsidy-lock unlock procedure for a wireless device, comprising:
receiving a security subsidy-lock unlock password;
initiating registration of the wireless device when the received password is determined to be correct;
receiving notification of a registration status; and
restricting or allowing network access based on the registration status.

2. The method of claim 1, wherein when the registration status indicates a successful registration, secure subsidy lock information is erased and network access is allowed.

3. The method of claim 2, wherein allowing network access comprises unlocking a display of the wireless device.

4. The method of claim 1, wherein when the registration status indicates an unsuccessful registration, network access is restricted.

5. The method of claim 4, wherein restricting network access comprises locking a display of the wireless device.

6. The method of claim 1, wherein the wireless device has a pre-defined list of networks pre-stored in a memory of the wireless device.

7. The method of claim 6, wherein initiating registration of the wireless device comprises selecting a first network on which to register from the predefined list of networks.

8. The method of claim 7, wherein when the registration status indicates an unsuccessful registration for the first network, network access is restricted.

9. The method of claim 8, wherein when registration on the first network is unsuccessful the wireless device successively attempts to register on remaining networks of the pre-defined list until there is a successful registration.

10. The method of claim 9, wherein network access is allowed upon successful registration on one of the remaining networks.

11. An apparatus comprising a wireless device for providing a secure subsidy-lock unlock procedure, comprising:
a controller that implements the security subsidy unlock procedure using:
a user interface to receive a security subsidy unlock password;
a comparator to determine whether the received subsidy unlock password is correct;
a transmitter to initiate registration of the wireless device with a network when the received password is determined to be correct;
a receiver to receive notification of a registration status from the network; and
the user interface to restrict or allow network access based on the registration status.

12. The wireless device of claim 11, wherein when the registration status indicates a successful registration, secure subsidy lock information is erased and network access is allowed.

13. The wireless device of claim 12, wherein allowing network access comprises unlocking a display of the wireless device.

14. The wireless device of claim 11, wherein when the registration status indicates an unsuccessful registration, network access is restricted.

15. The wireless device of claim 11, wherein the wireless device has a pre-defined list of networks pre-stored in a memory of the wireless device.

16. The wireless device of claim 15, wherein initiating registration of the wireless device comprises selecting a first network on which to register from the predefined list of networks.

17. The wireless device of claim 16, wherein when the registration status indicates an unsuccessful registration for the first network, network access is restricted.

18. The wireless device of claim 17, wherein when registration on the first network is unsuccessful the wireless device successively attempts to register on remaining networks of the pre-defined list until there is a successful registration.

19. The wireless device of claim 18, wherein network access is allowed upon successful registration on one of the remaining networks.

20. A computer-readable medium having stored thereon a plurality of instructions, the plurality of instructions including instructions which, when executed by a processor, cause the processor to perform the steps of a method for providing a secure subsidy-lock unlock procedure for a wireless device, comprising:
receiving a security subsidy-lock unlock password;
initiating registration of the wireless device when the received password is determined to be correct;
receiving notification of a registration status; and
restricting or allowing network access based on the registration status.
